(19) United States
(12) Patent Application Publication
(10) Pub. No.: US 2026/0203718 A1
(43) Pub. Date: Jul. 16, 2026

(54) SYSTEMS AND METHODS FOR AUTOMATED DYNAMIC SCHEDULE INTEGRATION

(71) Applicant: Wells Fargo Bank, N.A., San Francisco, CA (US)

(72) Inventors: Melissa Ann Kubasta, Moorhead, MN (US); Tosha Wesley Lyles, Charlotte, NC (US)

(21) Appl. No.: 19/016,680

(22) Filed: Jan. 10, 2025

(51) Int. Cl. G06Q 10/1093; G06Q 20/10

(52) U.S. Cl. CPC G06Q 10/1093; G06Q 20/102

(57) ABSTRACT

Systems, apparatuses, methods, and computer program products are disclosed for automated identification and monitoring of a user schedule. An example method includes retrieving user data associated with a user account. The example method further includes generating, based on the user data, a predictive scheduling algorithm. The example method further includes determining, using a schedule analysis model, a service event from the user data, and determining, using the schedule analysis model a service event type for the service event. The example method further includes determining, based on the user account and the service event type, a payment status for the service event. The example method further includes causing at least one of (i) an existing calendar event corresponding to the service event in the user schedule to be updated to reflect the payment status or (ii) a new calendar event for the service event to be generated in the user schedule.

### BACKGROUND

Schedule management systems allow for the planning, organizing, and controlling of activities or events to ensure they occur within a designated time frame. Managing schedules involves tracking deadlines, coordinating resources, and adjusting timelines to meet goals and maintain efficiency in operations.

### BRIEF SUMMARY

The technological field of automated financial transaction management has made strides, particularly with the introduction of online banking services and digital payment platforms like Zelle®. However, despite advancements in electronic payments, traditional methods of managing scheduling of entity payments remains largely manual and inefficient. The task of keeping track of recurring payments, reconciling one-time payments, and monitoring outstanding customer payments still relies heavily on human intervention. In addition, traditional payment scheduling management software solutions lack the seamless integration with payment platforms, and therefore lack the capability for automated payment scheduling and management.

Accordingly, the need for integrated scheduling of entity payments has historically been difficult to address. There exists no reliable method for entities to automatically align their financial transactions with their operational schedules. This includes synchronizing payments with recurring service events, one-time appointments, or event customer orders that are scheduled for future fulfillment. Traditionally, entity owners must manually review their calendars, invoices, and transaction histories to ensure payments are made on time and that incoming payments from customers are tracked, recorded, and followed up as needed. These processes often require significant manual input, introducing the risk of missed or incorrect payments. For example, an entity owner may manually schedule a monthly payment to a vendor for services. However, if there are changes to the payment amount or frequency, such adjustments must be remembered and updated across multiple systems. Similarly, monitoring customer payments may be a challenge, as the process of confirming whether a customer has paid and sending reminders or payment requests, often falls on the shoulders of the entity owner. Furthermore, current systems lack automated methods capable of analyzing historical transaction data and providing various functionalities, such as providing intelligent recommendations regarding payment schedules or to automatically sending notifications for anticipated payments. This lack of automation and integration with scheduling tools like calendars or event management systems results in missed payments, financial discrepancies, and general inefficiency in entity payment management. Accordingly, there exists an underlying technical necessity for systems that are autonomously able to provide these capabilities.

Example implementations described herein provide a technical solution to this technical problem. Moreover, example embodiments described herein utilize advanced technologies for streamlining and automating the scheduling and tracking of payments for entity owners. In particular, example embodiments described herein enable entity owners to seamlessly manage recurring payments, one-time payments, and anticipated customer payments in a single platform. By integrating payment management directly into the entity's schedule—whether through existing calendar systems or a proprietary scheduling interface, this technical solution ensures that payment events are aligned with the entity's operational timelines.

In particular, example embodiments described herein may determine a service event type to ensure alignment of payment management with the operational needs of an entity. The classification of service events ensures that each service event is accurately tracked and managed over time. To identify the service event type, example embodiments may analyze patterns within a user's historical data, evaluating the frequency, date, and context of past transactions and/or calendar entries associated with specific service providers. For recurring events, machine learning models may be employed to detect periodic patterns, recognizing instances which may repeat over a defined interval, such as monthly or quarterly payments. In contrast, one-time service events may be classified based on unique, non-repeating characteristics, often indicated by specific keywords or context within the transaction record or calendar entry. By accurately classifying the service event type, example embodiments may configure the appearance of the service event within the calendar to reflect the correct frequency, enabling automation of the necessary reminders and notifications and aligning the payment management system with the entity's operational cadence. This intelligent differentiation of service event types enables example embodiments to automate and simplify payment scheduling while reducing the potential for missed or duplicated payments.

In addition, example embodiments are capable of processing and integrating disparate data sources to autonomously infer, classify, and schedule service events. Unlike conventional systems that require user intervention, example embodiments retrieve, aggregates, and preprocesses multiple streams and data sources, such as historical transaction records, upcoming transactions, and calendar sources. A schedule analysis model is then trained to distinguish service events from this user data by applying non-standard, domain-specific rules that infer the likelihood of a service event being a one-time or recurring payment, classify the service event as an outgoing or incoming payment, and further associate it with a payment amount based on historical and/or upcoming transaction data.

Once a service event is determined, example embodiments further synchronize the service event with a corresponding calendar. That is, example embodiments verify whether a corresponding calendar event exists for the service event based on the timing and details of the calendar event. If no calendar event currently exists for the service event, example embodiments may generate a new calendar event for the service event. In some embodiments, a dynamic update mechanism continuously monitors transaction data and if a recurring pattern is detected, example embodiments may update calendar to reflect a recurring service event. Thus, example embodiments go beyond updating a calendar to add service events by providing a technical enhancement that automates complex scheduling processes in real-time, thereby resulting in a more intelligent, responsive calendar for the user.

By integrating payment management with the entity's calendar and automatically generating payment schedules, the risk of missed or late payments is significantly reduced as entity owners no longer need to manually track and schedule payments. This ultimately reduces the expenditure of costly computational resources and manual resources required to remedy late payments. In addition, the machine learning-based recommendation system further optimizes payment scheduling by identifying patterns in the entity's financial activity, providing tailored suggestions for recurring payments, and improving overall cash flow management. Additionally, example embodiments described herein allow for monitoring of anticipated payments, ensuring that entity owners remain informed of their financial status, allowing for timely follow-up and reducing payment delays.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for automated identification and monitoring of a user schedule.

FIG. 2 illustrates a schematic block diagram of example circuitry embodying a system device that may perform various operations in accordance with some example embodiments described herein.

FIG. 3 illustrates an example flowchart for automated identification and monitoring of a user schedule, in accordance with some example embodiments described herein.

FIG. 4 illustrates an example flowchart for determining a service event type for the service event, in accordance with some example embodiments described herein.

FIG. 5 illustrates another example flowchart for determining a payment status for the service event, in accordance with some example embodiments described herein.

FIG. 6 illustrates another example flowchart for causing reminders to be provided to the current responsible party in the user schedule, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

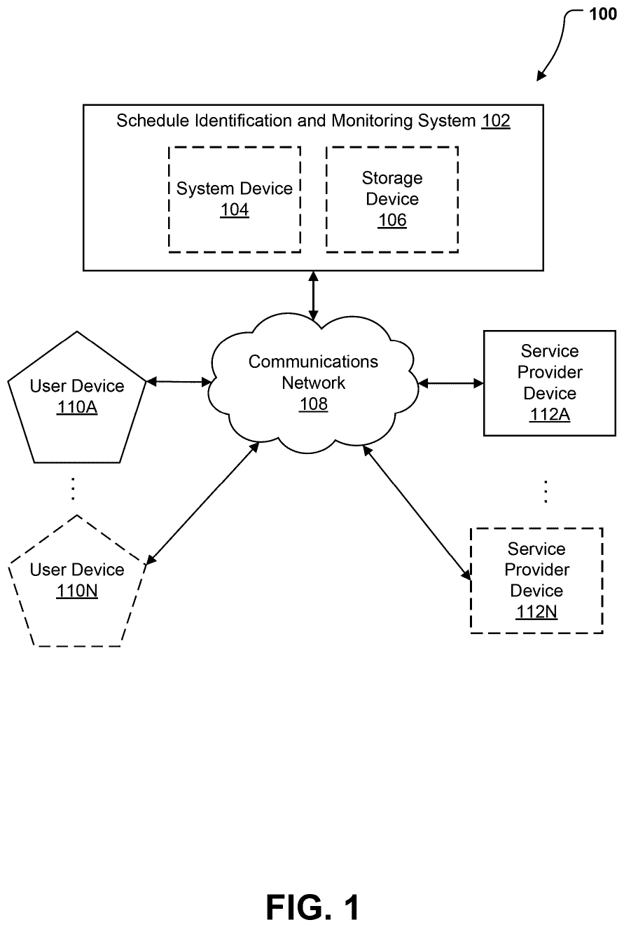

Example embodiments described herein may be implemented using any of a variety of computing devices or servers. To this end, FIG. 1 illustrates an example environment 100 within which various embodiments may operate. As illustrated, a schedule identification and monitoring system 102 may receive and/or transmit information via communications network 108 (e.g., the Internet) with any number of other devices, such as one or more of user devices 110A-110N and/or service provider devices 112A-112N. Although system device 104 and storage device 106 are described in singular form, some embodiments may utilize more than one system device 104, more than one storage device 106, and/or the like. The one or more user devices 110A-110N and/or service provider devices 112A-112N may be embodied by any computing devices known in the art. The one or more user devices 110A-110N and/or service provider devices 112A-112N need not themselves be independent devices but may be peripheral devices communicatively coupled to other computing devices. A user device 110A-110N may include laptops, tablets, phones, whereas a service provider device 112A-112N may be a device associated with a service provider that provides a service specific to the needs of a particular entity (e.g., an organization).

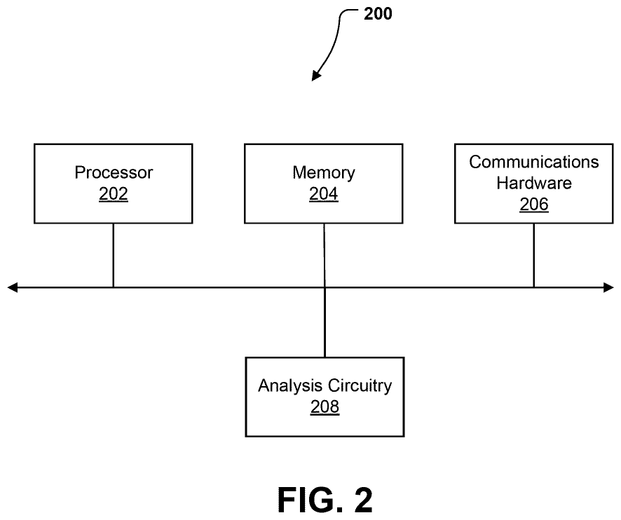

The schedule identification and monitoring system 102 may be implemented as one or more computing devices or servers, which may be composed of a series of components. These components of system device 104 may be physically proximate to the other components of the schedule identification and monitoring system 102, while other components are not. The system device 104 may receive, process, generate, and transmit data, signals, and electronic information to facilitate the operations of the schedule identification and monitoring system 102. Particular components of the schedule identification and monitoring system 102 are described in greater detail below with reference to apparatus 200 in connection with FIG. 2.

In some embodiments, the schedule identification and monitoring system 102 further includes a storage device 106 that comprises a distinct component from other components of the schedule identification and monitoring system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 106 may host the software executed to operate the schedule identification and monitoring system 102. Storage device 106 may store information relied upon during operation of the schedule identification and monitoring system 102, user data and documents to be analyzed using the schedule identification and monitoring system 102, or the like. In addition, storage device 106 may store control signals, device characteristics, and access credentials enabling interaction between the schedule identification and monitoring system 102 and one or more of the user devices 110A-110N and/or service provider devices 112A-112N.

Although FIG. 1 illustrates an environment and implementation in which the schedule identification and monitoring system 102 interacts indirectly with a user via one or more of user devices 110A-110N and/or service provider devices 112A-112N, in some embodiments users may directly interact with the schedule identification and monitoring system 102 (e.g., via communications hardware of the schedule identification and monitoring system 102), in which case separate user devices 110A-110N and/or service provider devices 112A-112N may not be utilized. Whether by way of direct interaction or indirect interaction via another device, a user may communicate with, operate, control, modify, or otherwise interact with the schedule identification and monitoring system 102 to perform the various functions and achieve the various benefits described herein.

### Example Implementing Apparatuses

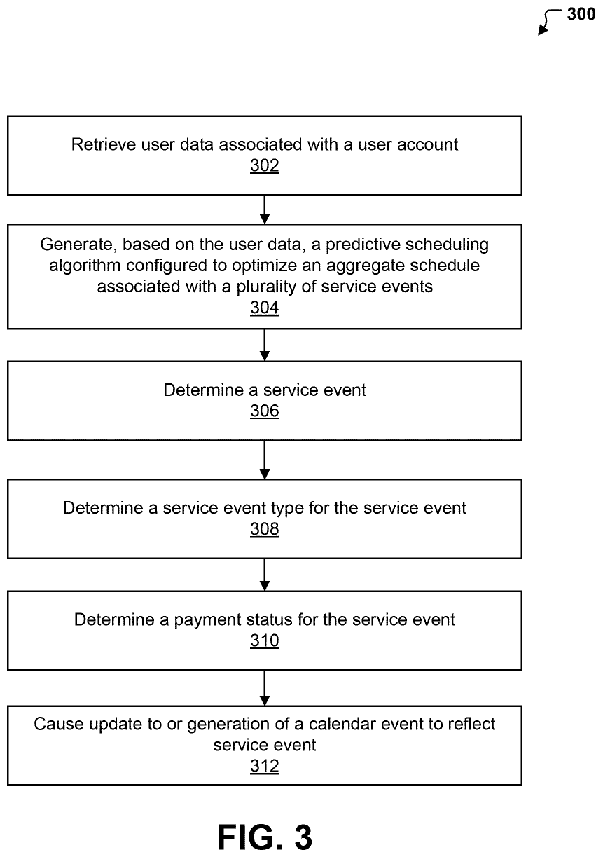

The schedule identification and monitoring system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, and analysis circuitry 208, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

The communications hardware 206 may be further configured to retrieve user data associated with a user account and output a reminder notification to the current responsible party, wherein the reminder notification comprises a reminder of the service event.

In addition, the apparatus 200 further comprises an analysis circuitry 208 that (i) determines, using a schedule analysis model, a service event from the user data, wherein the service event is associated with a service event date, (ii) determines, using the schedule analysis model, a service event type for the service event, (iii) determines, based on the user account and the service event type, a payment status for the service event, and (iv) causes, using the predictive scheduling algorithm at least one of (i) an existing calendar event corresponding to the service event in the user schedule to be updated to reflect the payment status or (ii) a new calendar event for the service event to be generated in the user schedule. The analysis circuitry 208 may utilize processor 202, memory 204, or any other hardware component included in the apparatus 200 to perform these operations, as described in connection with FIGS. 3-6 below. The analysis circuitry 208 may further utilize communications hardware 206 to gather data from a variety of sources (e.g., user devices 110A-110N, service provider devices 112A-112N and/or storage device 106, as shown in FIG. 1), and/or exchange data with a user and/or a service provider.

The analysis circuitry 208 may be further configured to generate, based on the user data, a predictive scheduling algorithm, and (i) in an instance in which the service event type corresponds to a recurring service event type, determine, using the schedule analysis model, a future service event, (ii) cause a new calendar event for the future service event to be generated in the user schedule, (iii) identify a plurality of historical service events associated with the user account, (iv) determine, using the schedule analysis model, whether the service event corresponds to one or more historical service events of the plurality of historical service events, (v) in an instance in which the service event corresponds to the one or more historical service events, determine, using the schedule analysis model, the service event type is the recurring service event type for the service event, (vi) determine, using the schedule analysis model, a confidence level for the service event type, wherein (a) the confidence level is indicative of an inferred confidence that the service event type for the service event is a recurring service event type and (b) the service event is determined to correspond to the one or more historical service events in an instance in which the confidence level satisfies a predefined threshold, (vii) generate, using the schedule analysis model, a sub-scheduling algorithm for the service event, wherein (a) the sub-scheduling algorithm defines parameters for a future event generation frequency and (b) the sub-scheduling algorithm generates the future service event, (viii) determine a payment amount for the service event, (ix) determine, based on the service event type and the payment amount, whether a user activity corresponding to the service event exists within the user account, wherein the payment status for the service event is based on whether the user activity corresponding to the service event exists within the user account and (x) determine, based on the payment status, a current responsible party for the service event,

Although components 202-208 are described in part using functional language, it will be understood that the particular implementations necessarily include the use of particular hardware. It should also be understood that certain of these components 202-208 may include similar or common hardware. For example, the analysis circuitry 208 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry”” may in addition refer to software instructions that configure the hardware components of the apparatus 200 to perform the various functions described herein.

Although the analysis circuitry 208 may leverage processor 202, memory 204, or communications hardware 206 as described above, it will be understood that the analysis circuitry 208 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that analysis circuitry 208 comprises particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

FIGS. 3-6 illustrate example flowcharts for automatically and dynamically integrating payment information with scheduling tools. The operations illustrated in FIGS. 3-6 may, for example, be performed by system device 104 of the schedule identification and monitoring system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, analysis circuitry 208, and/or any combination thereof. It will be understood that user interaction with the schedule identification and monitoring system 102 may occur directly via communications hardware 206 or may instead be facilitated by separate user devices 110A-110N and service provider devices 112A-112N, as shown in FIG. 1, and which may have similar or equivalent physical componentry facilitating such user interaction.

Turning first to FIG. 3, a procedure 300 illustrates example operations for automated identification and monitoring of a user schedule.

As shown by operation 302, the apparatus 200 includes means such as communications hardware 206, analysis circuitry 208, or the like, for retrieving user data associated with a user account. In some embodiments, user data may include calendar events, invoices, reminders, or other relevant data indicative of the business owner's payment obligations or anticipated receipts (e.g., aggregation of data from historical and upcoming calendar events and historical and upcoming transactions). The process of retrieving such user data may be performed by communications hardware 206 that may access a pre-configured user account within a digital payment platform. In some embodiments, the communications hardware 206 may receive a request from the user associated with the user account to enable integrated schedule management, subsequent to which the communications hardware 206 may establish a connection to the user's account database. The user account may store one or more types of user data such as: (i) business calendar data (e.g., calendar events created manually or synced with third-party calendar systems such as Google Calendar, Microsoft Outlook through an authorized API integration system), (ii) invoice data (e.g., uploaded invoices or payment requests detailing an owed amount, the recipient, due data), (iii) payment reminders (e.g., manually created or system-generated reminders which may indicate upcoming payments to be made or anticipated payments to be received from customers).

In some embodiments, the communications hardware 206 may receive a command from a user to authenticate the user account using multi-factor authentication (MFA) and confirm that the user has granted the schedule identification and monitoring system 102 access to relevant user data sources, including calendars or invoices. In some embodiments, this may involve obtaining OAuth tokens from third-party calendar providers to ensure secure access to the user account. Once authenticated, the communications hardware 206 may query the user data repository associated with the user account. In some embodiments, the user data repository may include a plurality of data fields containing event titles, descriptions, dates, times, and other metadata such as location and attendees. In other embodiments, the user data repository may contain invoice metadata, including invoice numbers, due dates, and payment amounts. In embodiments where the user data is associated with an external calendar system (e.g., Google Calendar), the communications hardware 206 may transmit a query to the calendar provider's API, requesting a data pull for events within a specified date range. For example, the communications hardware 206 may retrieve calendar events for the upcoming month to identify a service event.

In embodiments where the user data includes invoices, the communications hardware 206 may retrieve all available invoice files and extract relevant data fields, such as recipient details, payment due dates, and outstanding balances. In some embodiments, the communications hardware 206 may use optical character recognition (OCR) to process invoices uploaded in image format. Once retrieved, the user data may be validated for accuracy. In some implementations, the communications hardware 206 may check the data format and ensure that all required fields (e.g., event dates, payment amounts) are populated. This may include cross-referencing the retrieved data with other internal data sources, such as prior payment history or customer records, to ensure consistency.

In some embodiments, the communications hardware 206 may retrieve the user data from multiple sources or systems (e.g., multiple calendars, different invoice formats). In this case, the communications hardware 206 may normalize the user data by converting it into a unified format. For example, if events are retrieved from multiple calendar systems, the communications hardware 206 may combine them into a single data structure that is compatible with the schedule identification and monitoring system 102. Additionally, in some embodiments, to optimize performance, retrieved user data may be temporarily cached within a local storage device 106 associated with the schedule identification and monitoring system 102. This may ensure quick access to the user data for subsequent operations, such as identifying recurring payments or generating payment reminders.

Subsequent to receiving the user data associated with the user account, the analysis circuitry 208 may perform a filtering step to ensure only relevant transaction records and calendar events are processed for determination of a service event, as described below in connection with operation 306. In some embodiments, the filtering step may involve examining metadata associated with each calendar event (e.g., date, time, keywords, vendors, etc.). For example, the analysis circuitry 208 may use a filtering algorithm to filter transactions that fall outside a specific date range or exclude calendar events tagged as “personal” rather than “business”. Additionally, the filtering process may analyze the transaction amount or frequency. In some embodiments, where recurring payments are relevant, the filtering algorithm may exclude one-off transactions that do not align with established patterns of periodicity, thereby narrowing down to calendar events or transactions that exhibit a recurring pattern. In some embodiments, the filtering process may involve using machine learning techniques to assess patterns in the user data and assign probability scores to calendar events for relevance. For instance, a machine learning model trained on historical transactions may recognize a vendor's name that consistently appears in monthly expenses and assign a high relevance score to future transactions involving that particular vendor. Similarly, natural language processing may be used to analyze the text of calendar event descriptions to identify keywords or phrases, such as “payment due”, “invoice”, or “subscription renewal”. Based on the relevance score, the filtering step may allow the analysis circuitry 208 to exclude entries that fail to satisfy a particular threshold or parameter, thereby allowing only high-relevance events or transactions to be used for subsequent operations, while minimizing unnecessary processing of irrelevant user data.

As shown by operation 304, the apparatus 200 includes means such as analysis circuitry 208, or the like, for generating, based on the user data, a predictive scheduling algorithm configured to optimize an aggregate schedule associated with a plurality of service events. In some embodiments, the optimization is based on a forecasted inflow of revenue. In some embodiments, the predictive scheduling algorithm comprises one or more sub-scheduling algorithms associated with a particular service event. The received used data may include historical revenue patterns (e.g., cash inflow timing and amounts), payment histories for the plurality of service events, and a bank account balance of the user. In particular, the analysis circuitry 208 may use the aforementioned user data to identify key patterns, such as the typical timing of revenue inflows and the amounts associated with recurring income streams. In addition, in some embodiments, the user data may also include external factors, such as vendor-specific payment terms (e.g., late fees, discounts for early payment), which may be used as constraints in the optimization process.

To generate the predictive scheduling algorithm, the analysis circuitry 208 may use a machine learning model designed to forecast future cash inflows. In some embodiments, the predictive scheduling algorithm may predict the timing and amount of future revenue inflows using historical data and real-time financial inputs. For example, the analysis circuitry 208 may predict that $5000 in revenue may be deposited into the user's bank account on the 3^{rd} of the month based on past customer payment patterns. Subsequent to this prediction, the predictive scheduling algorithm may perform a cost-benefit analysis to evaluate the financial implications of paying a vendor on an alternate date. For instance, if a payment is due on the 1^{st} of a month, however, the predictive scheduling algorithm predicts significant incoming revenue on the 3^{rd} of the month, the predictive scheduling algorithm may calculate whether delaying the payment would be beneficial. In performing this analysis, the predictive scheduling algorithm may consider factors such as late payment fees, opportunity costs associated with having insufficient funds for other obligations, crude interest or penalties from late payments compared to the financial advantage of having more cash on hand. In summary, the predictive scheduling algorithm may determine the optimal payment date by balancing the cost-benefit analysis results. For example, the predictive scheduling algorithm may determine that paying the vendor on the 4^{th} of the month—despite a minor late fee—may still be more advantageous than paying on the 1^{st} of the month, given the incoming revenue on the 3^{rd} of the month.

Upon generation of the optimal payment schedule for a plurality of service events associated with multiple vendors, the analysis circuitry 208 may also perform additional actions based on the user's financial thresholds and permissions. In some embodiments, the analysis circuitry 208 may transmit a secure API request to a third-party account hosting the user's bank accounts to verify the current balance and confirm whether the current balance contains sufficient funds required to make a payment on the scheduled date. If at least one of the pending payment amounts and the available funds in the user's bank account fall within a predefined threshold, the analysis circuitry 208 may be configured to autonomously update the schedule. For instance, the analysis circuitry 208 may change the payment date for a vendor from the 1^{st} to the 4^{th}, without requiring user intervention. However, if the pending payment amount exceeds predefined threshold (e.g., $1000, or another user-defined limit), the analysis circuitry 208 may generate a notification to be outputted to the user via communications hardware 206. In particular, the notification may include the recommended payment date to a vendor, a justification for the change (e.g., forecasted inflow of revenue on the 3^{rd}), and a breakdown of any costs or penalties associated with the rescheduling. If the user has authorized autonomous payments, the analysis circuitry 208 may execute the payment to the vendor on the optimal date (e.g., the 4^{th}) using the linked financial account.

In some embodiments, the analysis circuitry 208 may enhance revenue forecasting accuracy by verifying the availability of funds for client payments. For instance, in the context of a small business owner operating a hair salon, if a client schedules a service such as a haircut that costs $300, the analysis circuitry 208 may initiate a query via the small business owner's bank server to verify whether the client's bank account is hosted by the same financial institution as the small business owner. By doing so, the analysis circuitry 208 may directly determine the availability of funds for the client. Alternatively, if the client's bank account is hosted by a different financial institution than that of the small business owner, the analysis circuitry 208 may prompt the small business owner's bank account server to transmit a request to the client's bank to confirm the availability of funds. In some embodiments, the analysis circuitry 208 may receive a binary indicator (e.g., “yes” or “no”) that indicates whether sufficient funds are available. This verification step ensures that the forecasted revenue from the scheduled service is reliable. If the analysis circuitry 208 determines that the client lacks sufficient funds, the analysis circuitry 208 may feed this data to the predictive scheduling algorithm so that the predictive scheduling algorithm may adjust the forecasted revenue of inflow, thereby preventing overreliance on unavailable income in payment scheduling or cash flow management decisions.

Operation 304 describes a process that enables small business owners to maintain a smooth cash flow without unnecessary delays or penalties and provides several technical and practical advantages. In particular, the aforementioned process aligns vendor payments with actual cash inflows, reducing the risk of overdrafts and maintaining liquidity, automates routine decisions while maintaining user control for high-value payments, continuously adapts to real-time financial updates, ensuring payment schedules remain optimal even if unexpected transactions occur or during periods of seasonal revenue variations, and balances penalties, interest, and cash availability to maximize financial efficiency for the user.

As shown by operation 306, the apparatus 200 includes means such as communications hardware 206, analysis circuitry 208, or the like, for determining a service event from the user data. A service event may refer to an event identified from the user data that represents a future action or interaction requiring payment or the provision of a service. In the context of entity payments, a service event may include any appointment, contract deliverable, invoice due date, or scheduled service (e.g., a recurring supply order or a maintenance visit). In general, the service event may involve an obligation for a user associated with the user account to pay a vendor or expect receipt of payment from a customer in exchange for a product or service (e.g., a service event may be an upcoming appointment for equipment maintenance, a recurring service such as waste management collection, or a one-time delivery of supplies). A service event date may refer to the specific date on which the service associated with the service event is scheduled to occur or when a payment is due. In some embodiments, the service event date may also represent a recurring cycle, such as weekly or monthly payments tied to an ongoing service. For instance, if a vendor service agreement specifies a maintenance service to be performed on the 15^{th} of every month, the service event date may be the 15^{th} of each applicable month.

A schedule analysis model may refer to a machine learning model used to analyze the user data and determine relevant service events. In some embodiments, the schedule analysis model may be designed to interpret raw calendar events, invoices, reminders, and other relevant data to extract meaningful patterns or insights. In some embodiments, the schedule analysis model may be configured to autonomously process and integrate various types of data sources to infer, classify, and schedule service events without manual user input. Unlike traditional scheduling systems that rely on user action, these embodiments may retrieve, aggregate, and preprocess diverse data streams, including historical transaction records, upcoming payments, and calendar entries. A schedule analysis model may then apply domain-specific rules to identify service events within the user data, determine whether each service event is a one-time or a recurring payment, classify it as an incoming or outgoing transaction, estimate a payment amount based on historical and anticipated transactions, and/or the like. Once a service event is identified, the analysis circuitry 208 may synchronize these service events with the relevant calendar. Specifically, the analysis circuitry 208 may check for existing calendar entries that align with the timing and details of the service event; if none exist, they can create a new calendar entry for that service event. In some implementations, a dynamic update mechanism may monitor transaction patterns, and if a recurring event is detected, the calendar may be updated to reflect its repeating nature. Therefore, integration of the schedule analysis model within this schedule management framework provides a significant technical advancement by automating complex scheduling tasks in real-time, resulting in a more intelligent and responsive calendar experience for the user.

Types of schedule analysis models which may be used include a pattern recognition model that processes historical user data to detect recurring service events or payments. For example, the schedule analysis model may identify that a particular vendor receives payments on a regular basis (e.g., every 30 days) and may use this pattern to determine future service events. In some embodiments, the schedule analysis model may refer to a natural language processing (NLP) model that analyzes text descriptions associated with calendar events or invoice details to identify keywords and phrases indicative of a service event. For example, if a calendar event is titled “Annual Contract Payment for XYZ Vendor”, the NLP model may identify this as a service event requiring payment on the specified date. In other embodiments, the schedule analysis model may be a rule-based model that uses predefined logic or rules to analyze the user data. For instance, rules may be set to flag any calendar event containing the words “payment”, “invoice”, or “service” as a potential service event. In some embodiments, the schedule analysis model may be a predictive model that predicts future service events based on the current user data and historical transaction trends. For example, the schedule analysis model may predict that after receiving an invoice, a payment will likely be required within 30 days.

To determine a service event from the user data, the user data may be input into the schedule analysis model. The user data may include calendar events, payment reminders, invoices, or other structured/unstructured scheduling information. In some embodiments, the analysis circuitry 208 in conjunction with the schedule analysis model (pattern-recognition based) may analyze historical payment data to identify recurring patterns. For example, if a user has a record of paying a specific vendor every three months for office supplies, the schedule analysis model may identify a similar recurring service event for the upcoming payment period. In other words, the analysis circuitry 208 may identify any event that aligns with this pattern and mark it as a service event. The associated date of this service event may be labeled as the service event date. In other embodiments with an NLP-based schedule analysis model, the analysis circuitry 208 may process the text within calendar event titles, descriptions, or invoice notes. The analysis circuitry 208 may extract keywords and phrases (e.g., “service”, “payment due”, “delivery”, “invoice due”), and classify these as potential service events. Once the service event is identified, the analysis circuitry 208 may extract the associated service event date, which may either be explicitly stated in the user data or may be inferred based on the event's time metadata. In alternate embodiments that uses a rule-based model, the analysis circuitry 208 may apply predetermined rules to the user data. For example, any service event which includes the keyword “payment” and occurs within 30 days may be flagged as a service event. The analysis circuitry 208 may then designate the event date specified in the user data as the service event data. In some embodiments, where the schedule analysis model is a predictive model, the analysis circuitry 208 may project the occurrence of a future service event based on historical trends and customer behavior. For example, if a customer makes biweekly payments for a subscription service, the schedule analysis model may predict the next payment due date and label the next payment due date as a service event. The analysis circuitry 208 may then generate one or more future service event dates based on this predicted trend.

In some embodiments, once the service event and service event date are determined, the analysis circuitry 208 may transfer the projected service event dates for storage in storage device 106 via communications hardware 206. In some embodiments, the communications hardware 206 may notify the user associated with the user account that a projected service event date has been determined for a particular vendor and/or customer.

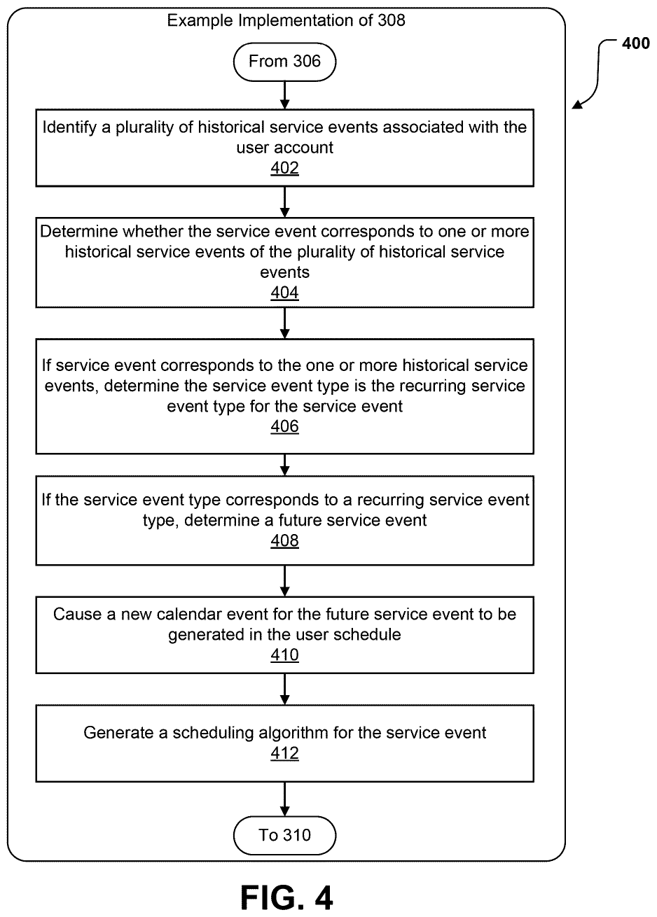

As shown by operation 308, the apparatus 200 includes means such as communications hardware 206, analysis circuitry 208, or the like, for determining, using the schedule analysis model, a service event type for the service event. Once a service event has been identified, the details of the service event, including metadata (e.g., event description, date, and related payment data) may be used by the schedule analysis model to further process the service event information and determine a service event type, as described in connection with FIG. 4 below.

In some embodiments, operation 308 may be performed in accordance with the operations described in FIG. 4. Turning now to FIG. 4, a procedure 400 illustrates example operations for determining, using the schedule analysis model, a service event type for the service event.

As shown by operation 402, the apparatus 200 includes means such as communications hardware 206, analysis circuitry 208, or the like, for identifying a plurality of historical service events associated with the user account. In some embodiments, the process of identifying a plurality of historical service events associated with the user account may begin with the communications hardware 206 accessing the relevant user account data associated with the user account within a digital payment platform. The communications hardware 206 may perform this by querying a database or cloud storage system where all transaction histories, payment records, calendar events, and other entity-related interactions are stored. In some embodiments, the schedule identification and monitoring system 102 may use a historical event retrieval engine to query the database for extraction of relevant service events. The historical event retrieval engine may be configured to handle large datasets and filter historical data based on predefined criteria. In some embodiments, the query initiated by the historical event retrieval engine may be designed to filter service events using the predefined criteria, wherein the query is constrained by time periods (e.g., the last 12 months), event types (e.g., payments only, recurring service events, delivery events), service event identifiers (e.g., service provider names), and/or the like.

Once the predefined criteria are set, the database query may be executed by the communications hardware 206, subsequent to which retrieval of matching records may be extracted. In some embodiments, the database query may retrieve all relevant fields for each historical event, including event title (e.g., service payment for HVAC, invoice payment to ABC Corp, etc.), event date (e.g., the exact date of the historical event), event description (e.g., additional text regarding the event or the transaction), service provider information (e.g., the vendor or service provider associated with the event), payment or transaction information (e.g., any transaction records tied to the event, such as payment amounts, invoice numbers, or bank details).

In some embodiments, the analysis circuitry 208 must account for variability in how historical service events are labeled or recorded. In some embodiments, the analysis circuitry 208 may apply data normalization techniques to standardize the event titles or descriptions. For instance, “vendor payment—ABC supplies” and “invoice payment—ABC supplies”, might refer to the same type of event but may be stored under slightly different names. Data normalization ensures that similar events are recognized as equivalent for accurate comparison. For example, if a user labeled previous payments with variations such as “payment for services—ABC” and consultation fee for ABC”, the analysis circuitry 208 may apply normalization to recognize both as being for the same service provider and may categorize both as professional service payment event types.

In some embodiments, not all historical service events are relevant for identification of the service event type. The analysis circuitry 208 may use filtering algorithms to exclude non-relevant events, such as personal appointments or unrelated transactions. For example, if the user's calendar includes non-business events like “birthday party” or “doctor's appointment”, these may be excluded from the pool of historical service events through predefined filtering criteria.

In some embodiments, the analysis circuitry 208 may use a natural language processing-based schedule analysis model to analyze the text of historical service event titles or descriptions, extracting contextual information to match events with the current service event. For example, an event titled “invoice payment to XYZ Corp” is recognized as a payment event, even if the specific wording may be different from the current event (e.g., Payment due for XYZ Corp). As another example, if a historical service event description includes “quarterly payment for maintenance”, the NLP model may identify the context of a recurring payment and associate it with the appropriate category.

In some embodiments, the analysis circuitry 208 may cross-reference historical service events with stored transaction data to identify patterns. For example, if multiple events involve payments to the same service provider (e.g., “ABC Supplies”), the analysis circuitry 208 may recognize these as recurring vendor payment vents. Thus, the cross-referencing process helps the analysis circuitry 208 confirm whether the identified service events are consistent with the current service event. For example, the analysis circuitry 208 may identify that over the past six months, there have been regular payments made to “ABC Supplies” for inventory. This may lead the analysis circuitry 208 to classify the historical service events as inventory payment events.

In some embodiments, the analysis circuitry 208 may support real-time processing, in which case the analysis circuitry 208 may continuously update the list of identified historical service events as new user data is added to the user account. For example, as more historical service events are processed or added to the system, the list may be dynamically updated to include the most relevant matches.

As shown by operation 404, the apparatus 200 includes means such as communications hardware 206, analysis circuitry 208, or the like, for determining whether the service event corresponds to one or more historical service events of the plurality of historical service events. In some embodiments, the schedule analysis model may compare the service event against one or more historical service events to determine whether the service event corresponds to one or more historical service events of the plurality of historical service events. In some embodiments, the schedule analysis model may contain an algorithm that performs pattern matching between the current service event and each of the plurality of historical service events. The analysis circuitry 208 may then retrieve the characteristics of the service event (e.g., service provider, description, amount, and date), and compare those details against the historical service events stored in the user's account. Examples of key factors used in the comparison may include, (i) service provider name (e.g., the system may check if a payment to “XYZ Corp” matches any historical payments made to the same entity), (ii) transaction amount (e.g., the system may compare the payment amount or service fee associated with the service event to those of historical events, wherein a match or a value within a threshold such as +/−5% variance may indicate a recurring pattern), (iii) event description (e.g., using NLP, the analysis circuitry 208 may analyze the text descriptions of events to identify similarities in wording, such as “monthly cleaning” or “quarterly subscription payment”), event date (e.g., if a service event occurs at regular intervals similar to historical events, such as every month, quarter, or year, this may strengthen the correspondence), and/or the like.

In some embodiments, the schedule analysis model may assign a weighted similarity score to each comparison mentioned above, based on how closely the parameters match the historical service events. Each parameter (e.g., service provider, amount, description, date) may be weighted according to its importance in identifying recurring events. For instance, service provider and transaction amounts may be given higher weight than the exact event description or date.

In some embodiments, the schedule analysis model may establish a threshold score to decide if the current service event corresponds to one or more historical service events. If the similarity score exceeds a predefined threshold (e.g., 80%), the analysis circuitry 208 may determine that the service event corresponds to the historical service event. In cases where the score below the threshold, the analysis circuitry 208 may classify the service event as a new or unique service event. For example, a user may have a historical record of paying a cleaning service “Clean Corp”, $100 every month on the 15^{th}. A current service event for $102 on the 15^{th} to the same service provider would likely yield a high similarity score, indicating correspondence and determining that the service event corresponds to that particular historical service event.

As shown by operation 406, the apparatus 200 includes means such as analysis circuitry 208 or the like, for determining the service event type is the recurring service event type for the service event when the service event corresponds to the one or more historical service events. Once the schedule analysis model determines that the service event corresponds to the historical service event, the next step may be to identify whether the service event qualifies as a recurring service event type. This operation is crucial for establishing whether the service event is part of a regularly occurring schedule. In some embodiments, the schedule analysis model may comprise a recurrence detection sub-model that may analyze the identified correspondence to confirm if the service event represents a recurring pattern. The schedule analysis model may review the timing intervals between the current service event and the historical service event. Examples of key factors in determining recurrence may include frequency (e.g., the schedule analysis model may check whether the service event follows a regular interval such as weekly, monthly, quarterly, or annually), and may verify if the service event occurs on or around the same day of each period (e.g., the 1^{st} of every month or the last Friday of every quarter). Based on the recurrence pattern, the schedule analysis model may categorize the service event as a recurring service event type. Examples of recurring service event types may include a subscription payment (e.g., for cloud storage or SaaS platforms), maintenance fees (e.g., recurring payments for services like equipment maintenance or cleaning), utility payments (e.g., monthly payments for electricity of water). In some embodiments, the schedule analysis model may apply a classification threshold based on the number of past occurrences required to classify the event as a recurring service event type. For instance, at least three matching historical service events might be needed before classifying the current event as a recurring service event type.

As shown by operation 408, the apparatus 200 includes means such as analysis circuitry 208 or the like, for determining a future service event when the service event type corresponds to a recurring service event type. Once the service event is identified as a recurring service event type, the schedule analysis model may forecast future occurrences based on the established pattern. In some embodiments, the schedule analysis model may include a forecasting engine that uses the historical data of recurring events to predict the next instance off the service event and may further review the intervals between the previous occurrences to project the next likely occurrence based on the recurring pattern. In some embodiments, the schedule analysis model may perform this by calculating the average interval between the current service event and the historical service events. For example, if the interval between the historical service event and the service event is 30 days, the schedule analysis model may predict that the next service event will occur in 30 days from the current event's date.

In some embodiments, the schedule analysis model may adjust for calendar anomalies such as weekends or public holidays. For example, if the future service event is predicted to fall on a weekend, the schedule analysis model may adjust the future service event to the nearest business day. Further, the schedule analysis model may account for leap years, holidays, or user-specified preferences in scheduling (e.g., only allowing payments on weekdays).

As shown by operation 410, the apparatus 200 includes means such as, communications hardware 206, analysis circuitry 208, or the like, for causing a new calendar event for the future service event to be generated in the user schedule. In some embodiments, the analysis circuitry 208 may leverage a calendar API (e.g., Google Calendar, Microsoft Outlook) to directly interface with the user's digital calendar. In some embodiments, the analysis circuitry 208 may be authorized to access the user account calendar through a secure authentication mechanism (e.g., OAuth). Once authenticated, the analysis circuitry 208 may cause a new calendar event for the future service event to be generated in the user schedule.

In some embodiments, the analysis circuitry 208 may leverage communications hardware 206 to send a request to the calendar API to generate a new calendar event for the identified future service event. The new event entry may include the future event title, future event date, future event time, future event frequency, notification settings (e.g., reminders or alerts to notify the user of the upcoming event), and/or the like.

In some embodiments, if the calendar event conflicts with existing entries, the analysis circuitry 208 may use logic to resolve the conflict. This may involve notifying the user or adjusting the time or date of the event based on availability. In some embodiments, the analysis circuitry 208 may also account for blackout periods or public holidays, ensuring that the future service event is scheduled on a valid working day. For example, if a user has a recurring payment for a monthly office cleaning, the analysis circuitry 208 may create a future service event for the next cleaning payment on the 15^{th} of the upcoming month. The future service event may appear in the user schedule with details about the payment amount, the vendor, and the recurrence schedule.

As shown by operation 412, the apparatus 200 includes means such as analysis circuitry 208 or the like, for generating, based on the predictive scheduling algorithm, a sub-scheduling algorithm for the service event. In some embodiments the sub-scheduling algorithm may define parameters for a future event generation frequency and further, the sub-scheduling algorithm may generate the future service event. A sub-scheduling algorithm may govern how future service events are created, including their frequency and timing. Further, the sub-scheduling algorithm may ensure that future service events are automatically scheduled without manual intervention. In particular, the schedule analysis model may incorporate a sub-scheduling algorithm generation module that creates a custom algorithm for managing future service events. The sub-scheduling algorithm may be based on the historical patterns and the current service event data. In addition, the schedule analysis model may be based on the historical service event patterns and the current service event data. In some embodiments, the sub-scheduling algorithm may define the specific parameters need for future service event scheduling, including event frequency (e.g., the algorithm determines the frequency with which the service event should recur—this could be daily, weekly, monthly, quarterly, annually, or based on any custom interval derived from the historical service event data), event duration (e.g., the duration of the recurring service event—i.e., it recurs indefinitely, or there may be an end date for the series of recurring service events), event amount (e.g., the amount associated with the recurring payment or service), event type (e.g., whether the event is a payment, service delivery, or appointment), and/or the like.

In some embodiments, the sub-scheduling algorithm may be represented as a structured set of rules or code logic, such as:
Service Event Recurrence Rules:
Frequency: Monthly (every 30 days)
Event type: Payment
Amount: $200
Start Date: current service event date
Recurrence: indefinite
Adjustment for Holidays: Yes

In some embodiments, the sub-scheduling algorithm may be capable of adjusting the scheduling based on holidays, weekends, or other user-defined parameters.

Once the sub-scheduling algorithm is defined, the analysis circuitry 208 may automatically use the sub-scheduling algorithm to generate future service events. In addition, the analysis circuitry 208 may process the rules defined in the sub-scheduling algorithm to forecast and schedule these events on the user schedule. In some embodiments, the analysis circuitry 208 may maintain a queue of future service events, with each event being generated at the specified frequency (e.g., the 15^{th} of every month for monthly payments).

In some embodiments, the sub-scheduling algorithm may be dynamic and adjustable based on changes in the parameters of the service event. For example, if the payment amount or frequency changes, the sub-scheduling algorithm may update the future service events accordingly. In some embodiments, the schedule analysis model may also refine the sub-scheduling algorithm based on user feedback or additional service event data that may emerge over time. In some embodiments, the sub-scheduling algorithm may be capable of handling exceptions, such as missed payments or service cancellations. For example, if a scheduled service event is skipped due to the entity being closed on a holiday, the sub-scheduling algorithm may re-generate the future service event for the next appropriate date.

Returning to FIG. 3, as shown by operation 310, the apparatus 200 includes means such as communications hardware 206, analysis circuitry 208, or the like, for determining a payment status for the service event. This operation involves analyzing both the user's payment history and the specific characteristics of the service event to identify the current status of the payment. In particular, operation 310 may integrate information about the user account's transaction history, the service event type, and real-time data about any transactional interactions related to the event by collecting input data, service event data, subsequent to which a payment status determination step may be performed by analysis circuitry 208.

First, the analysis circuitry 208 may retrieve historical transaction data associated with the user's account, such as transaction history, outstanding payments, and/or any associated service agreements or contracts. In some embodiments, the historical transaction data may include past payments, recurring payments, invoices, account balance, and transaction logs to evaluate the current standing of the user's financial obligations. In some embodiments, the analysis circuitry 208 may also use the previously determined service event type to help guide the payment status check. Different service event types (e.g., one-time payments, recurring payments, appointments), may have different payment structures and requirements. For example, a recurring payment event may need to verify whether the user is on schedule for regular payments, whereas a one-time payment event may only verify whether the payment has been made or is overdue.

In some embodiments, the analysis circuitry 208 may attempt to match the current service event with previously completed payments in the user account's transaction history and may search the transaction log for any records of payments that match the service event type and service event date. In addition, the system may check for payments to the service provider, the amount paid, and whether the payment amount corresponds to the expected payment for the service event. Based on the results of the matching process, the analysis circuitry 208 may classify the service event into one of several possible payment status categories: paid, pending (e.g., if a payment has been initiated, but it hasn't been fully processed or cleared), overdue, not paid, scheduled, etc.

In some embodiments, the communications hardware 206 may communicate with external financial platforms (e.g., the bank associated with the user's digital payment platform account) and/or the service provider device 112A-112N through secure APIs to retrieve real-time information regarding any pending or completed payments. In embodiments where the payment status is pending, the analysis circuitry 208 may continue to monitor these APIs for updates, transitioning the status to “paid” once the transaction is finalized. For example, for a recurring monthly payment of $200 to a vendor, the analysis circuitry 208 may check the payment history for similar payments made at monthly intervals. If a payment is found for the current month's due date, the payment status may be marked as “paid”. If no payment is found, the payment status may be marked as “overdue” or “not paid” depending on the due date. As an alternate example, for a one-time payment scheduled for a specific vendor service, the analysis circuitry 208 may check for the exact transaction in the payment history. If the transaction has been processed, the payment status may be marked as “paid”. If no matching transaction is found and the payment date has passed, the payment status may be marked as “overdue”.

In some embodiments, if the system detects partial payments (e.g., if the full amount has not been paid), the analysis circuitry 208 may assign a payment status of “partially paid” and send a notification to the user to settle the balance. In other embodiments, if the service event involves anticipated payments from customers, the analysis circuitry 208 may track incoming transactions to the user's account. If a payment is expected but not yet received, the analysis circuitry 208 may assign a status of “pending” and continue monitoring for the expected payment. In other embodiments, where the service event involves multiple smaller payments (e.g., a payment plan), the analysis circuitry 208 may evaluate whether each installment has been made on time. If a partial amount is missing, the status for the payment amount may be marked as “partially paid”, or “overdue”.

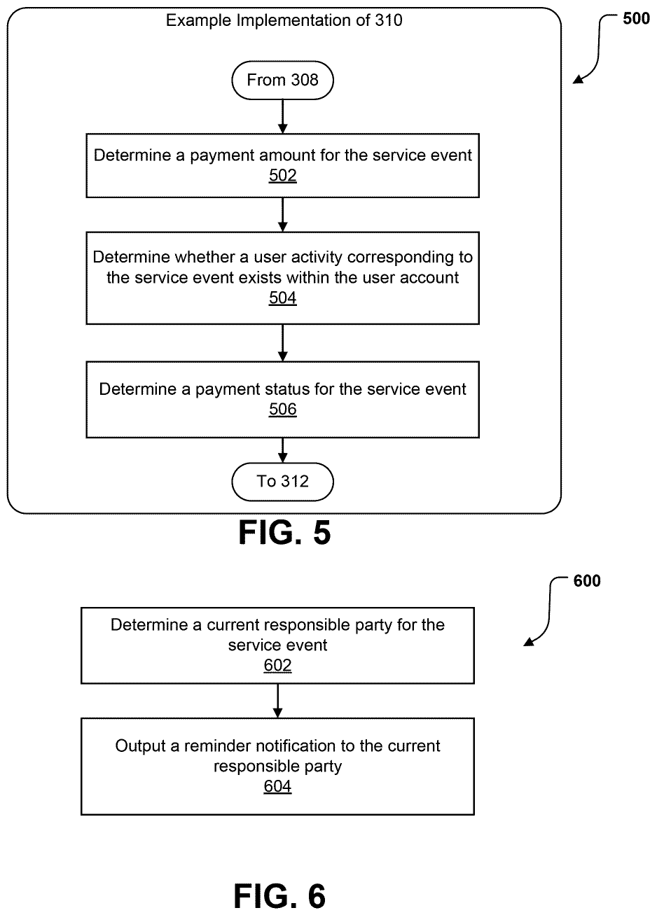

In some embodiments, operation 310 may be performed in accordance with the operations described in FIG. 5. Turning now to FIG. 5, a procedure 500 illustrates example operations for determining, based on the user account and the service event type, a payment status for the service event.

As shown by operation 502, the apparatus 200 includes means such as communications hardware 206, analysis circuitry 208 or the like, for determining a payment amount for the service event. Determining the payment amount for the service event involves identifying or calculating the amount that the user is required to pay for a specific service event. In some embodiments, the payment amount may be derived from several factors, including historical payments, invoices, or predefined service agreements. In particular, for analysis of the payment history, the analysis circuitry 208 may analyze historical transaction data associated with a historical service event to identify previous payments made for a similar service event. For example, if the user has a recurring payment to a specific vendor for $200 every month, the analysis circuitry 208 may recognize this recurring pattern and automatically determine the payment amount for the next service event to be $200.

In other embodiments, the payment amount for the service event may not be directly linked to the historical transaction data associated with the historical service event, but rather, may be directly linked to an uploaded or received invoice. In this case, the analysis circuitry 208 may parse the invoice using optical character recognition (OCR) technology, identifying the relevant payment amount, vendor details, and due date. In addition, the invoice processing engine may read this data and may calculate the exact amount owed. For example, if a user uploads an invoice for a one-time repair service of $350, the analysis circuitry 208 may extract this figure and assign it as the payment amount for a future service event.

In some embodiments, for pre-defined services with fixed fees (e.g., a contracted monthly subscription), the analysis circuitry 208 may refer to a stored service agreement associated with the user account to determine the payment amount. For example, if the user has contracted a service with a vendor for a fixed amount of $150 per month, this payment amount may automatically be set as the payment amount for each recurring service event.

In some embodiments, the payment amount may be dynamically calculated based on variables such as service usage, customer interactions, or discounts. For instance, a utility company charges based on usage. In this case, the analysis circuitry 208 may calculate the payment amount based on the usage data from the user's account for the given billing period.

As shown by operation 504, the apparatus 200 includes means such as, communications hardware 206, analysis circuitry 208, or the like, for determining whether a user activity corresponding to the service event exists within the user account. In other words, operation 504 is directed towards determining whether there is evidence of user activity, such as a payment or a service acknowledgement that corresponds to the service event. In some embodiments, the analysis circuitry 208 may perform this by cross-referencing the service event type and payment amount with any matching activity in the user account to ensure that the service event has been acted upon. In doing so, the analysis circuitry may determine the payment status for the service event based on whether the user activity corresponding to the service event exists within the user account.

In some embodiments, the analysis circuitry 208 may identify the service event type (e.g., recurring payment, one-time payment, or subscription service), and the associated payment amount. Based on the service event type, the analysis circuitry 208 may filter user activities in the user account that may correspond to the specific service event type. For example, a “recurring payment” service event type would trigger the analysis circuitry 208 to search for recurring transactions in the user's payment history. Subsequently, the analysis circuitry 208 may perform a query on the user account to identify any matching activity that corresponds to the expected payment. This includes searching for transaction history, pending or completed payments, manual activity (e.g., user engagement such as confirming receipt of a service or approving a payment manually), and/or the like.

As shown by operation 506, the apparatus 200 includes means such as analysis circuitry 208, or the like, for determining the payment status for the service event based on whether the user activity exists within the user account. Once the analysis circuitry 208 identifies the corresponding user activity, the analysis circuitry 208 may assign a payment status based on whether the payment has been made or not. If no matching activity is found (e.g., the payment was missed), the analysis circuitry 208 may assign a status of “not paid” or “overdue”. If the user activity is pending or partially paid, the analysis circuitry 208 may assign a status of “pending” or “partially paid”.

Returning to FIG. 3, as shown by operation 312, the apparatus 200 includes means such as communications hardware 206, analysis circuitry 208, or the like, for causing, using the predictive scheduling algorithm, an update to or generation of calendar event to reflect the service event. In particular the analysis circuitry 208 may cause at least one of (i) an existing calendar event corresponding to the service event in the user schedule to be updated to reflect the payment status or (ii) a new calendar event for the service event to be generated in the user schedule. In some embodiments, if the service event is already represented in the user schedule (e.g., as a recurring payment or scheduled service), the analysis circuitry 208 may update the service event to reflect the latest payment status. The update may include the status update (e.g., paid, pending, overdue, etc.). In some embodiments, if the payment is overdue or pending the analysis circuitry 208 may add or modify notification settings to remind the user of the status change (e.g., sending alerts one day before the payment is due).

In some embodiments, if no existing calendar event corresponds to the service event, the analysis circuitry 208 may generate a new calendar event in the user schedule. The new calendar event may reflect the service event, the service event type, and the determined payment system. The analysis circuitry 208 may send a request to the calendar API (e.g., Google Calendar, Outlook) to create a new event, which includes the event title, event date, payment status, reminder settings, and/or the like.

In some embodiments, if the new calendar event conflicts with existing events, the analysis circuitry 208 may allow the user to manually modify the new calendar event and/or the reminders associated with the new calendar event.

Turning now to FIG. 6, a procedure 600 illustrates example operations for causing reminders to be provided to the current responsible party.

As shown by operation 602, the apparatus 200 includes means such as communications hardware 206, analysis circuitry 208, or the like, for determining a current responsible party for the service event. A responsible party may refer to the user providing the service, a vendor, a customer, a service provider, and/or the like, depending on the service event, service event type, and the payment status associated with the service event. In some embodiments, the analysis circuitry 208 may first evaluate the payment status of the service event. Examples of possible status may include (not paid, paid, pending). Based on the payment status, the analysis circuitry 208 may determine who is responsible for taking action related to the service event. In general, if the payment status is “not paid” or “pending”, the user associated with the user account may be responsible for ensuring the payment is made or confirming the completion of the transaction. In other embodiments, if the payment status is “paid”, the responsibility may shift to the vendor or service provider, who must acknowledge the payment and deliver the agreed-upon services. In alternate embodiments, if the service event involves an anticipated payment from a customer, the customer may become the responsible party. For example, a customer has scheduled a service with the user but has not yet paid; the customer would be the responsible party to complete the payment in this scenario.

In some embodiments, for more complex service events involving multiple parties (e.g., subcontractors or third-party vendors), the analysis circuitry 208 may cross-reference payment agreements or contracts associated with the service event to identify which entity is currently responsible for the payment. For example, in a situation where a subcontractor is involves, the analysis circuitry 208 may determine that the subcontractor is responsible for providing a portion of the service once the primary vendor has been paid by the user.

In some embodiments, the analysis circuitry 208 may also perform a lookup of the user account, vendor and/or service provider records, and/or customer account details to determine the current responsible party for the payment.

As shown by operation 604, the apparatus 200 includes means such as communications hardware 206, analysis circuitry 208, or the like, for outputting a reminder notification to the current responsible party, wherein the reminder notification comprises a reminder of the service event. Once the responsible party is identified, the analysis circuitry 208 may generate and transmit a reminder notification to inform the responsible party of their role in the service event. This ensures that the responsible party is aware of the service event and any associated actions they need to take (e.g., making a payment, confirming service delivery). The communications hardware 206 may generate a reminder notification which may include a reminder text (e.g., a message detailing the service event, its status, and any action required), service event details (e.g., information about the event, such as the service provider, the amount due, the due date, and the nature of the service), action required (e.g., specific instructions on what the responsibility party must do next), and/or the like.

In some embodiments, the reminder notification may be transmitted in various formats depending on the preferences set by the responsible party, including email, SMS, push notification, in-app notification, and/or the like. In some embodiments, the analysis circuitry 208 may be configured to send the reminder at various intervals depending on the urgency of the service event: (i) pre-event reminder (e.g., sent before the service event date, reminding the responsible party of the upcoming event), (ii) overdue reminder (e.g., if a payment or action is overdue, the reminder notification may be more urgent), (iii) scheduled follow-ups (e.g., periodic reminders until the service event is completed or the payment status is updated), and/or the like.

In some embodiments, the communications hardware 206 may customize the content of the reminder based on the service event type and the preferences of the responsible party. For instance, a recurring service event (e.g., monthly subscription) might include a standardized message, while a one-time event might require more detailed instructions about the specific payment or service required.

In some embodiments, the communications hardware 206 may use the user account data to ensure the reminder is sent to the correct recipient. If the vendor is responsible, the communications hardware 206 may retrieve contact details (e.g., email, phone number) from the vendor's account and may send the reminder accordingly. In other embodiments where a customer is responsible for a payment or an action, the communications hardware 206 may access the customer's contact details stored in the user account. In cases where a user is responsible, the communications hardware 206 may send a notification to the user's designated contact method.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved schedule management and payment tracking for entities. Example embodiments thus provide tools that overcome the problems faced by entity owners in managing recurring and one-time payments. By avoiding the need to manually perform scheduling of payment events, example embodiments thus save time and resources, while also eliminating the possibility of human error that has been unavoidable in the past. Moreover, embodiments described herein avoid the inefficiencies and inaccuracies commonly associated with manual payment tracking and scheduling. Finally, by automating functionality that has historically required human analysis, the speed and consistency of the evaluations performed by example embodiments unlocks many potential new functions that have historically not been available, such as the ability to conduct near-real-time payment reconciliation.

The example embodiments described herein provide an advanced, automated approach to managing service events and payment schedules. By autonomously integrating multiple data streams—such as transaction histories, upcoming payments, and calendar data—example embodiments streamline the identification, classification, and scheduling of service events without requiring user intervention. In particular, the application of a schedule analysis model that leverages domain-specific rules enables the schedule identification and monitoring system 102 to accurately classify service events as one-time, recurring, outgoing, incoming, and/or the like, and determine payment amounts based on historical patterns. Furthermore, by dynamically updating the user's calendar to reflect these events in real-time, example embodiments ensure an up-to-date, intelligent scheduling experience for the user. Such a technical solution not only simplifies complex scheduling tasks, but also provides users with a reliable and responsive calendar, minimizing administrative burdens while reducing the risk of missed or redundant payments.

As these examples all illustrate, example embodiments contemplated herein provide technical solutions that solve real-world problems faced during payment schedule management. And while managing scheduling of payments has been an issue for decades, the recently exploding amount of data made available by recently emerging technology today has made this problem significantly more acute, as the demand for efficient payment management scheduling systems has grown significantly even while the complexity of managing multiple transactions has itself increased. At the same time, the recently arising ubiquity of digital payment platforms has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for automated identification and monitoring of a user schedule, the method comprising:
retrieving, by communications hardware, user data associated with a user account;
generating, by the analysis circuitry and based on the user data, a predictive scheduling algorithm configured to optimize an aggregate schedule associated with a plurality of service events;
determining, by analysis circuitry and using a schedule analysis model, a service event from the user data, wherein the service event is associated with a service event date;
determining, by the analysis circuitry and using the schedule analysis model, a service event type for the service event;
determining, by the analysis circuitry and based on the user account and the service event type, a payment status for the service event; and
causing, by the analysis circuitry and using the predictive scheduling algorithm, at least one of (i) an existing calendar event corresponding to the service event in the user schedule to be updated to reflect the payment status or (ii) a new calendar event for the service event to be generated in the user schedule.

2. The method of claim 1, further comprising:
in an instance in which the service event type corresponds to a recurring service event type, determining, by the analysis circuitry and using the schedule analysis model, a future service event; and
causing, by the analysis circuitry, a new calendar event for the future service event to be generated in the user schedule.

3. The method of claim 2, further comprising:
identifying, by the analysis circuitry, a plurality of historical service events associated with the user account;
determining, by the analysis circuitry and using the schedule analysis model, whether the service event corresponds to one or more historical service events of the plurality of historical service events; and
in an instance in which the service event corresponds to the one or more historical service events, determining, by the analysis circuitry and using the schedule analysis model, the service event type is the recurring service event type for the service event.

4. The method of claim 3, further comprising:
determining, by the analysis circuitry and using the schedule analysis model, a confidence level for the service event type, wherein (a) the confidence level is indicative of an inferred confidence that the service event type for the service event is a recurring service event type and (b) the service event is determined to correspond to the one or more historical service events in an instance in which the confidence level satisfies a predefined threshold.

5. The method of claim 2, further comprising:
generating, by the analysis circuitry and using the schedule analysis model, and based on the predictive scheduling algorithm, a sub-scheduling algorithm for the service event, wherein (a) the sub-scheduling algorithm defines parameters for a future event generation frequency and (b) the sub-scheduling algorithm generates the future service event.

6. The method of claim 1, further comprising:
determining, by the analysis circuitry, a payment amount for the service event; and
determining, by the analysis circuitry and based on the service event type and the payment amount, whether a user activity corresponding to the service event exists within the user account, wherein the payment status for the service event is based on whether the user activity corresponding to the service event exists within the user account.

7. The method of claim 1, further comprising:
determining, by the analysis circuitry and based on the payment status, a current responsible party for the service event; and
outputting, by the communications hardware, a reminder notification to the current responsible party, wherein the reminder notification comprises a reminder of the service event.

8. An apparatus for automated identification and monitoring of a user schedule, the apparatus comprising:
communications hardware configured to:
retrieve user data associated with a user account; and
analysis circuitry configured to:
generate, based on the user data, a predictive scheduling algorithm configured to optimize an aggregate schedule associated with a plurality of service events,
determining, using a schedule analysis model, a service event from the user data, wherein the service event is associated with a service event date,
determine, using the schedule analysis model, a service event type for the service event,
determine, based on the user account and the service event type, a payment status for the service event, and
cause, using the predictive scheduling algorithm at least one of (i) an existing calendar event corresponding to the service event in the user schedule to be updated to reflect the payment status or (ii) a new calendar event for the service event to be generated in the user schedule.

9. The apparatus of claim 8, wherein the analysis circuitry is further configured to:
in an instance in which the service event type corresponds to a recurring service event type, determine, using the schedule analysis model, a future service event; and
cause a new calendar event for the future service event to be generated in the user schedule.

10. The apparatus of claim 9, wherein the analysis circuitry is further configured to:
identify a plurality of historical service events associated with the user account;
determine, using the schedule analysis model, whether the service event corresponds to one or more historical service events of the plurality of historical service events; and
in an instance in which the service event corresponds to the one or more historical service events, determine, using the schedule analysis model, the service event type is the recurring service event type for the service event.

11. The apparatus of claim 10, wherein the analysis circuitry is further configured to:
determine, using the schedule analysis model, a confidence level for the service event type, wherein (a) the confidence level is indicative of an inferred confidence that the service event type for the service event is a recurring service event type and (b) the service event is determined to correspond to the one or more historical service events in an instance in which the confidence level satisfies a predefined threshold.

12. The apparatus of claim 9, wherein the analysis circuitry is further configured to:
generate, using the schedule analysis model and based on the predictive scheduling algorithm, a sub-scheduling algorithm, a sub-scheduling algorithm for the service event, wherein (a) the sub-scheduling algorithm defines parameters for a future event generation frequency and (b) the sub-scheduling algorithm generates the future service event.

13. The apparatus of claim 8, wherein the analysis circuitry is further configured to:
determine a payment amount for the service event; and
determine, based on the service event type and the payment amount, whether a user activity corresponding to the service event exists within the user account, wherein the payment status for the service event is based on whether the user activity corresponding to the service event exists within the user account.

14. The apparatus of claim 8, wherein the analysis circuitry is further configured to:
determine, based on the payment status, a current responsible party for the service event,
wherein the communications hardware is further configured to output a reminder notification to the current responsible party, wherein the reminder notification comprises a reminder of the service event.

15. A computer program product for automated identification and monitoring of a user schedule, the computer program product comprising at least one non-transitory computer readable storage medium storing software instructions that, when executed, cause an apparatus to:
retrieve user data associated with a user account;
generate, based on the user data, a predictive scheduling algorithm configured to optimize an aggregate schedule associated with a plurality of service events;
determine, using a schedule analysis model, a service event from the user data, wherein the service event is associated with a service event date;
determine, using the schedule analysis model, a service event type for the service event;
determine, based on the user account and the service event type, a payment status for the service event; and
cause, using the predictive scheduling algorithm at least one of (i) an existing calendar event corresponding to the service event in the user schedule to be updated to reflect the payment status or (ii) a new calendar event for the service event to be generated in the user schedule.

16. The computer program product of claim 15, wherein the software instructions, when executed, further cause the apparatus to:
in an instance in which the service event type corresponds to a recurring service event type, determine, using the schedule analysis model, a future service event; and
cause a new calendar event for the future service event to be generated in the user schedule.

17. The computer program product of claim 16, wherein the software instructions, when executed, further cause the apparatus to:
identify, a plurality of historical service events associated with the user account;
determine, using the schedule analysis model, whether the service event corresponds to one or more historical service events of the plurality of historical service events; and
in an instance in which the service event corresponds to the one or more historical service events, determine, using the schedule analysis model, the service event type is the recurring service event type for the service event.

18. The computer program product of claim 17, wherein the software instructions, when executed, further cause the apparatus to:
determine, using the schedule analysis model, a confidence level for the service event type, wherein (a) the confidence level is indicative of an inferred confidence that the service event type for the service event is a recurring service event type and (b) the service event is determined to correspond to the one or more historical service events in an instance in which the confidence level satisfies a predefined threshold.

19. The computer program product of claim 16, wherein the software instructions, when executed, further cause the apparatus to:
generate, using the schedule analysis model and based on the predictive scheduling algorithm, a sub-scheduling algorithm, a sub-scheduling algorithm for the service event, wherein (a) the sub-scheduling algorithm defines parameters for a future event generation frequency and (b) the sub-scheduling algorithm generates the future service event.

20. The computer program product of claim 15, wherein the software instructions, when executed, further cause the apparatus to:
determine a payment amount for the service event; and
determine, based on the service event type and the payment amount, whether a user activity corresponding to the service event exists within the user account, wherein the payment status for the service event is based on whether the user activity corresponding to the service event exists within the user account.
